(19) United States
(12) Patent Application Publication
(10) Pub. No.: US 2023/0215613 A1
(43) Pub. Date: Jul. 6, 2023

(54) THERMAL MANAGEMENT OF ELECTROMAGNETIC DEVICE

(71) Applicant: Murata Manufacturing Co., Ltd., Nagaokakyo-shi (JP)

(72) Inventor: Kapila WARNAKULASURIYA, Milton Keynes (GB)

(21) Appl. No.: 18/119,726

(22) Filed: Mar. 9, 2023

Related U.S. Application Data
(63) Continuation of application No. PCT/GB2021/051945, filed on Jul. 28, 2021.

(30) Foreign Application Priority Data
Jul. 29, 2020 (GB) 2011747.9

(51) Int. Cl. H01F 27/22; H01F 27/02

(52) U.S. Cl. CPC H01F 27/22; H01F 27/025

(57) ABSTRACT

An electromagnetic device is provided with improved thermal management. The electromagnetic device includes a core assembly and one or more sets of windings wrapped around the core assembly. The core assembly is constructed from a plurality of U-shaped cores, or from a plurality of U-shaped cores and I-shaped cores in combination. Various arrangements of thermally conductive plates disposed within the core assembly are provided. The thermally conductive plates transfer heat away from the core assembly to improve the thermal characteristics of the electromagnetic device.

### CROSS REFERENCE TO RELATED APPLICATIONS

This application claims the benefit of priority to United Kingdom Patent Application No. 2011747.9 filed on Jul. 29, 2020 and is a Continuation Application of PCT Application No. PCT/GB2021/051945 filed on Jul. 28, 2021. The entire contents of each application are hereby incorporated herein by reference.

### BACKGROUND OF THE INVENTION

### 1. Field of the Invention

This application relates to thermal management of an electromagnetic device, such as a transformer, and in particular to an electromagnetic device and a core assembly suitable for an electromagnetic device.

### 2. Description of the Related Art

Electromagnetic devices such as transformers, including high power high frequency (HPHF) transformers, inherently experience losses which result in heat production in the transformer core and windings. Advancements in the field have helped to reduce these losses. For example, Murata's pdqb winding technology (UK patent application GB2574481, the entire contents of which are incorporated herein by reference) makes it possible to achieve the theoretically minimum level of high frequency conductor losses in HPHF transformers. However, as the demand for power levels increase, the need for very high power levels in a compact structure is desired. Such high power levels result in very high loss densities in compact HPHF transformers.

Build-up of heat in the core and windings of a transformer can cause degradation of the magnetic properties of the core, degradation of the insulation properties of the winding insulator, and a reduction in the lifetime of the transformer. In extreme cases, severe damage through melting of components and electrical breakdown can result in catastrophic failure of the device.

Typically, the core and the dimensions of transformers have been increased in size as per the results of thermal models to maintain temperature rises at reasonable levels. Effective removal of heat from such transformers is therefore desired to allow operation with a lower temperature rise for a given size, to allow further miniaturization of transformers such as HPHF transformers.

It is desirable to provide an improved thermal management system for an electromagnetic device such as a transformer, to prevent internal temperature rises, and to aid further miniaturization of transformers such as HPHF transformers.

### SUMMARY OF THE INVENTION

According to a first preferred embodiment of the present invention, an electromagnetic device is provided. The electromagnetic device includes one or more sets of windings and a core assembly. The core assembly includes one or more core layers, wherein each core layer includes two closed cores, and each closed core is constructed either from two U-shaped cores or from a U-shaped core and an I-shaped core. The core assembly further includes a thermally conductive plate that is disposed between the closed cores along the axial direction of the one or more sets of windings, so as to bisect the one or more core layers. Each set of windings passes through each of the closed cores, and the thermally conductive plate is in thermal contact with the closed cores to transfer heat away from the interior of the core assembly.

The preferred embodiments of the present invention facilitate efficient removal of heat from the center and interior of the core assembly of the electromagnetic device, as well as reduction of the hot spot temperature of the core. Furthermore, the preferred embodiments of the present invention result in a reduction in the amount of heat transferred to the windings from the heat generated by the core, therefore reducing an increase in the winding temperature. The improved thermal management allows a reduction in size of the electromagnetic device and components as effective removal of heat allows operation with a lower temperature rise for a given size. Therefore, use of the thermally conductive plates allows further miniaturization of transformers, such as HPHF transformers, due to reduced temperature related constraints. Moreover, the improved thermal management can prolong the lifetime of the device and prevent determination of the magnetic properties of the core.

The electromagnetic device may further include, in the case of a plurality of core layers, one or more secondary thermally conductive plates disposed between the core layers. The one or more secondary thermally conductive plates may be disposed in a plane parallel or substantially parallel within manufacturing and/or measurement tolerances to the axial direction of the one or more sets of windings and orthogonal or substantially orthogonal within manufacturing and/or measurement tolerances to the plane of the thermally conductive plate. These secondary thermally conductive plates can increase the efficiency of the extraction of heat from the core assembly, by increasing the area of contact between the thermally conductive plates and the U-shaped cores and I-shaped cores.

The one or more secondary thermally conductive plates may be adjacent to and in thermal contact with the thermally conductive plate that is disposed between the closed cores. The secondary thermally conductive plates being in thermal contact with the thermally conductive plate that is disposed between the closed cores allows heat extracted by the secondary thermally conductive plates to flow into the (primary) thermally conductive plate, which can increase thermal efficiency.

The electromagnetic device may further include a thermally conductive housing including a frame and an outer casing. The thermally conductive housing may be in thermal contact with at least the thermally conductive plate of the core assembly. Removal of heat from the core assembly can be achieved via the thermally conductive housing to improve the thermal management of the device. Moreover, the thermally conductive housing provides mechanical protection for the electromagnetic device.

The frame may include gaps which prevent a low resistance electrical path being created via the frame through the electromagnetic device parallel or substantially parallel within manufacturing and/or measurement tolerances to the axial direction of the one or more sets of windings. This prevents any circulating currents from forming that would reduce efficiency and generate additional losses.

The frame of the thermally conductive housing may include corner portions which extend orthogonally or substantially orthogonally within manufacturing and/or measurement tolerances to the plane of the thermally conductive plate and parallel or substantially parallel within manufacturing and/or measurement tolerances to the core layers. The thermally conductive plate may have a first end and a second end. The thermally conductive plate may include cut-out portions at the first end, which prevent electrical contact with the corner portions at the first end of the thermally conductive plate, so as to prevent a low resistance electrical path being created via the thermally conductive plate through the electromagnetic device parallel or substantially parallel within manufacturing and/or measurement tolerances to the axial direction of the one or more sets of windings. Again, this can prevent electrical shorting from occurring.

The thermally conductive plate may be in thermal contact with the corner portions towards the second end of the thermally conductive plate. This allows heat to be transferred from the thermally conductive plate to the thermally conductive housing, thus improving the thermal management of the device.

The thermally conductive plate may be in thermal contact with the outer casing of the thermally conductive housing at the second end of the thermally conductive plate. A gap may be formed between the outer casing and the first end of the thermally conductive plate, so as to prevent a low resistance electrical path being created via the thermally conductive plate through the electromagnetic device parallel or substantially parallel within manufacturing and/or measurement tolerances to the axial direction of the one or more sets of windings.

Connecting the outer casing in this fashion provides strong thermal conductivity to remove heat extracted by the thermally conductive plates, while prevent shorting through the center of the device from occurring.

The one or more secondary thermally conductive plates may be in contact with the outer casing at one end of each of the one or more secondary thermally conductive plates. A gap may be included between the outer casing and the other end of each of the one or more secondary thermally conductive plates, so as to prevent a low resistance electrical path being created via the one or more secondary thermally conductive plates through the electromagnetic device parallel or substantially parallel within manufacturing and/or measurement tolerances to the axial direction of the one or more sets of windings.

Connecting the outer casing to the secondary thermally conductive plates can allow heat to be removed from the secondary thermally conductive plates directly, which helps improve the thermal management of the device. The gaps prevent a short occurring through the center of the device.

The frame of the thermally conductive housing may be in thermal contact with the peripheral core layers. This allows heat to be transferred from the U-shaped cores directly to the thermally conductive housing, improving the thermal management of the device.

The electromagnetic device may further include one or more thermally conductive blocks disposed adjacent to the one or more sets of windings and extending orthogonally or substantially orthogonally within manufacturing and/or measurement tolerances to the axial direction of the one or more sets of windings. The thermally conductive blocks may be in thermal contact with the one or more sets of windings to transfer heat away from the one or more sets of windings. The one or more thermally conductive blocks may be in thermal contact with the thermally conductive housing.

The thermally conductive blocks allow heat removal from the windings of the electromagnetic device, therefore providing further improvement in the thermal management of the device.

A gap may be formed between one end of each of the one or more thermally conductive blocks and the thermally conductive housing to prevent a low resistance electrical path being created through the electromagnetic device via the one or more thermally conductive blocks. This prevents any circulating currents being formed through the thermally conductive blocks due to induced voltages from the main magnetic field. The electromagnetic device includes two thermally conductive blocks, and the two thermally conductive blocks are positioned on opposite sides of the one or more sets of windings and are rotationally symmetric about the winding axis of the one or more sets of windings. Such a configuration allows heat to be extracted evenly from both sides of the device, while preventing a low resistance electrical path from being formed through the device.

The thermally conductive plate may be in thermal contact with a cooling structure either directly or indirectly via the thermally conductive housing. The one or more thermally conductive blocks may also be in thermal contact with a cooling structure either directly, or indirectly via the thermally conductive housing. The cooling structure may include one or more cooling plates and/or one or more radiating elements.

The cooling structure allows removal of the heat extracted from the interior of the core assembly by the thermally conductive plates, allowing a reduction in the core temperature of the electromagnetic device.

One or more radiating elements may be mounted on and thermally connected to the exterior of the outer casing to aid effective heat removal.

The one or more sets of windings may be formed from flat wire. The one or more sets of windings may be formed from square turns or substantially square turns within manufacturing and/or measurement tolerances. The one or more sets of windings may include input and output terminals that extend orthogonally or substantially orthogonally within manufacturing and/or measurement tolerances to the one or more core layers. The windings may be Murata's pdqb type windings, for example. The disk nature of flat wire windings such as pdqb windings helps to facilitate the improved thermal management approach.

At least one of the thermally conductive plates, the one or more secondary thermally conductive plates, the one or more thermally conductive blocks, and the thermally conductive housing may be made of aluminum or copper. These materials have a high thermally conductivity, while being non-magnetic so as to not disrupt the magnetic properties of the transformer. Aluminum can be substituted with copper in space critical applications for the further improvement of the efficacy.

The electromagnetic device may be transformer.

According to a first preferred embodiment of the present invention, a core assembly suitable for an electromagnetic device is provided. The core assembly includes one or more core layers. Each core layer includes two closed cores, and each closed core is constructed either from two U-shaped cores or from a U-shaped core and an I-shaped core. A thermally conductive plate that is disposed between the closed cores so as to bisect the one or more core layers. The thermally conductive plate is configured to transfer heat away from the interior of the core assembly.

The preferred embodiments of the present invention facilitate efficient removal of heat from the center and interior of the core assembly, as well as reduction of the hot spot temperature of the core.

The preferred embodiments of the present invention provide a thermal management system for an electromagnetic device such as a transformer, including but not limited to HPHF transformers. The thermal management system can be applied in particular to pdqb winding transformers; however. the preferred embodiments of the present invention are not limited to pdqb type transformers.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows a perspective view of a core assembly and windings in a preferred embodiment of the present invention.

FIG. 2 shows a perspective view of a core assembly and windings in another preferred embodiment of the present invention.

FIG. 3 shows a cutaway view of the core assembly and windings of FIG. 2.

FIG. 4 shows a perspective view of an electromagnetic device with a thermally conductive housing including the core assembly and winding of FIG. 1.

FIG. 5 shows a cutaway view of a core assembly in another preferred embodiment of the present invention.

FIG. 6 shows a cutaway view of a core assembly in another preferred embodiment of the present invention.

FIG. 7 shows a perspective view of an electromagnetic device with a thermally conductive housing.

FIG. 8 shows an alternative perspective view of the electromagnetic device of FIG. 7.

FIG. 9 shows a cutaway view of FIG. 8.

FIG. 10 shows a front view of the electromagnetic device of FIG. 7.

FIG. 11 shows a side view of the electromagnetic device of FIG. 7.

FIG. 12 shows a rear view of the electromagnetic device of FIG. 7.

FIG. 13 shows a side view of the electromagnetic device of FIG. 7.

FIG. 14 shows a perspective view of a core assembly and windings in a preferred embodiment of the present invention.

FIG. 15 shows a cutaway plan view of FIG. 14.

FIG. 16 shows a partially constructed view of an electromagnetic device including the core assembly and windings of FIG. 14.

FIG. 17 shows a partially constructed view of an electromagnetic device including the core assembly and windings of FIG. 14.

FIG. 18 shows a perspective view of an electromagnetic device in a preferred embodiment of the present invention.

### DETAILED DESCRIPTION OF THE PREFERRED EMBODIMENTS

An electromagnetic device with improved thermal management is disclosed. The electromagnetic device includes a core assembly and one or more sets of windings wrapped around the core assembly. The core assembly is constructed from a plurality of U-shaped cores, or from a plurality of U-shaped cores and I-shaped cores in combination. Various arrangements of thermally conductive plates disposed within the core assembly are disclosed. The thermally conductive plates transfer heat away from the core assembly to improve the thermal characteristics of the electromagnetic device.

An electromagnetic device includes any device that stores or transfers energy via a magnetic field, such as a transformer, inductor, or choke. The preferred embodiments of the present invention can be applied in any such electromagnetic device. This description focuses on the case of a transformer as the electromagnetic device.

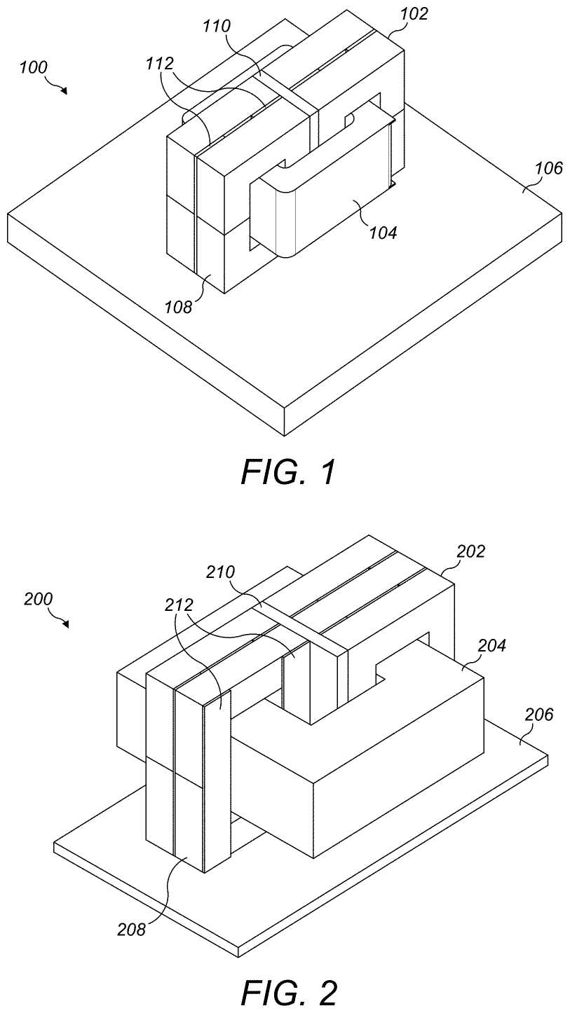

FIG. 1 shows a perspective view of a core assembly 102 and windings 104 of a transformer device 100 of a preferred embodiment of the present invention. The core assembly 102 is mounted on a base 106. The windings 104 are wrapped around the core assembly 102. The transformer device 100 can be a high frequency transformer, a high voltage transformer, a HPHF transformer, or the like. A single phase shell type transformer is shown in FIG. 1 and throughout this specification; however, preferred embodiments of the present invention could also be applied in multiphase shell type transformers and multiphase core type transformers.

The core assembly 102 of FIG. 1 includes a UU type core constructed from eight U-shaped cores 108. Although UU type cores will be used as the main example throughout this description, UI type cores could also be used as an alternative, or in combination with UU type cores. The U-shaped cores are combined to create a closed core. Two closed cores are then combined to construct a core layer. When only U-shaped cores are used, each core layer will include four U-shaped cores. Two of these core layers are then stacked to create the core assembly 102 in FIG. 1, however more than two layers could be used. Therefore, in general, the number of U-shaped cores used varies in multiples of four, depending on the application. Multiple core layers are typically used at higher power levels. The U-shaped cores 108 are made from a magnetic material such as a ferrite material.

The core assembly 102 further includes a primary thermally conductive plate 110 and may optionally include one or more secondary thermally conductive plates 112. The primary and secondary thermally conductive plates 110, 112 can be made from a material with a high thermal conductivity that will not disrupt the magnetic properties of the transformer. For example, a non-magnetic metal could be used, such as aluminum or copper.

The primary thermally conductive plate 110 is disposed between adjacent U-shaped cores 108, so as to pass through the center of the windings 104 along the axial direction of the windings and bisect the core layers created by the sets of four U-shaped cores 108. The one or more secondary thermally conductive plates 112 are disposed between adjacent U-shaped cores, between the core layers, in a plane orthogonal or substantially orthogonal within manufacturing and/or measurement tolerances to the plane of the primary thermally conductive plate 110 and parallel or substantially parallel within manufacturing and/or measurement tolerances the axial direction of the windings. Multiple core layers and therefore at least eight U-shaped cores 108 can be used in the case where secondary thermally conductive plates 112 are included. The primary and secondary thermally conductive plates 110, 112 are positioned in planes which are parallel or substantially parallel within manufacturing and/or measurement tolerances to the magnetic field inside the core, so as to have no effect or substantially reduced effect on the magnetic circuit.

The primary and secondary thermally conductive plates 110, 112 transfer heat away from the interior of the core assembly 102 via conduction. The heat can be transferred away from the device via various cooling structures, as will be further detailed below. In this preferred embodiment, the primary and secondary thermally conductive plates 110, 112 transfer the extracted heat to the base 106, which can be mounted on a cooling plate, for example. Alternatively, various radiating structures can be used. For example, the thermally conductive plates may provide a path for the heat generated in the core to flow to one or more radiation surfaces.

A primary thermally conductive plate 110 may be used alone without the secondary thermally conductive plates 112. Alternatively, secondary thermally conductive plates 112 may be included both adjacent to the primary thermally conductive plate 110 and adjacent to the outer edge of the core assembly 102. In some preferred embodiments, only some of the secondary thermally conductive plates 112 may be included, for example, only the secondary thermally conductive plates 112 adjacent to the primary thermally conductive plate 110 may be included, and the secondary thermally conductive plates 112 adjacent to the outer edge of the core assembly 102 may be omitted, or vice versa. In some preferred embodiments, the secondary thermally conductive plates 112 may be thinner than the primary thermally conductive plate 110. Addition of the secondary conductive plates 112 can increase the amount of heat extracted from the core compared to the primary thermally conductive plate 110 alone, due to the increased contact area with the U-shaped cores.

Aluminum is typically used for the thermally conductive plates; however, aluminum plates can be substituted with copper plates in space critical applications for the further improvement of the efficacy. Aluminum typically has a thermal conductivity of over fifty times that of the core material, and copper typically has a thermal conductivity nearly 100 times larger than the core material. A combination of various different materials may be used for the primary and secondary thermally conductive plates 110, 112 in a single core assembly 102.

The introduction of the primary and secondary thermally conductive plates 110, 112 improves the effectiveness of the thermal management of the transformer device significantly. For example, the hot spot temperature of the core can be reduced by more than 20° C. by the primary and secondary thermally conductive plates 110, 112. Removing heat produced in the core assembly 102 can prevent heat being transferred from the core to the windings, and therefore can also prevent the winding temperature increasing. The improved thermal management of the core assembly 102 can prevent failure of the device and allow further miniaturization of the device, as well as preventing degradation of the magnetic properties of the core.

In the case of a multiphase transformer, multiple primary thermally conductive plates 110 could be used. Each core layer would include more than four U-shaped cores, increasing by two U-shaped cores with each extra phase, and the primary thermally conductive plates 110 would pass through each core layer a number of times, between each pair of closed cores. A multitude of secondary thermally conductive plates 112 could be disposed between the core layers.

A number of different winding arrangements could be used for the windings 104. For example, round wire windings or flat wire windings may be used. The windings may be formed from square turns or substantially square turns within manufacturing and/or measurement tolerances. The windings 104 include input and output terminals extending orthogonally or substantially orthogonally within manufacturing and/or measurement tolerances to the one or more core layers (not shown). The windings may be Murata's pdqb type windings, as detailed in UK patent application GB2574481, the entire contents of which are incorporated herein by reference.

Alternatively other winding arrangements could be used. More than one set of windings may be used as the windings 104, and each set of windings may contain a number of different coils, for example, primary and secondary coils, or may instead contain a single coil. The windings 104 may be insulated through various arrangements or structures such a coating on the windings or encasing the windings in a cast resin or the like. The windings could also be insulated through the use of Kapton® tape or the like.

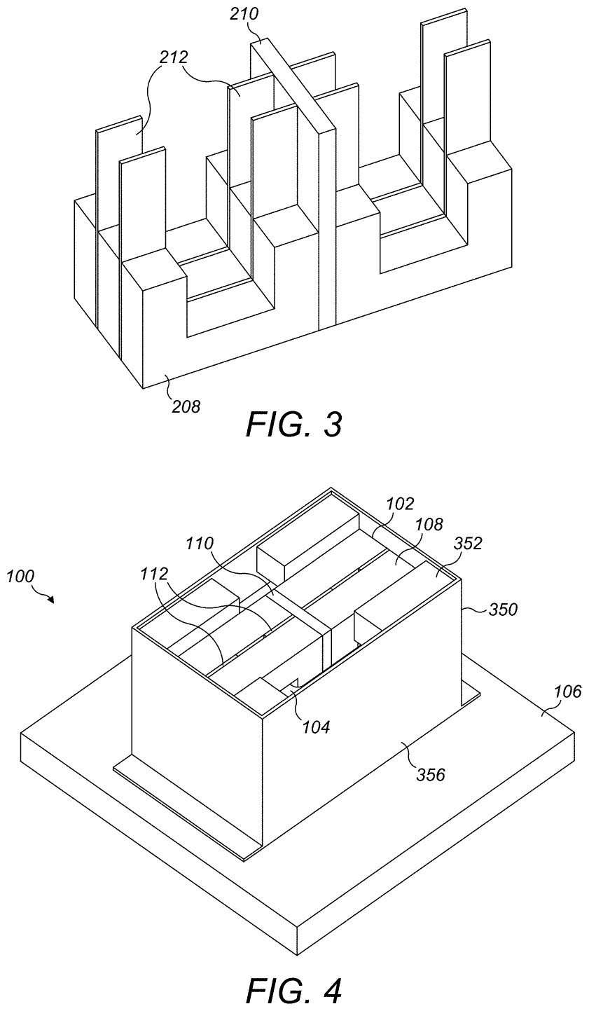

FIGS. 2 and 3 focus on an alternative core assembly and thermally conductive plate arrangement. FIG. 2 shows a preferred embodiment of a transformer device 200 which is equivalent to the transformer device 100 of FIG. 1, except that twelve U-shaped cores are used in the preferred embodiment of FIG. 2 to create three core layers. The transformer device 200 of FIG. 2 includes a core assembly 202, windings 204, a base 206, twelve U-shaped cores 208, a primary thermally conductive plate 210, and eight secondary thermally conductive plates 212. Two of the U-shaped cores are not shown in FIG. 2 to provide a complete view of the secondary thermally conductive plates 212. The secondary thermally conductive plates 212 are disposed between the first and second core layer and between the second and third core layer.

FIG. 3 shows a cutaway view of the core assembly and thermally conductive plate arrangement of FIG. 2 in more detail. In FIG. 3 the windings 204 and the two upper U-shaped cores 208 from each core layer have been removed for illustrative purposes, leaving only the six lower U-shaped cores 208 and the primary and secondary thermally conductive plates 210, 212 remaining. As can be seen in FIG. 3, the secondary thermally conductive plates 212 are disposed in a plane orthogonal or substantially orthogonal within manufacturing and/or measurement tolerances to the plane of the thermally conductive plate. The secondary thermally conductive plates 12 may be thinner than the primary thermally conductive plate 210.

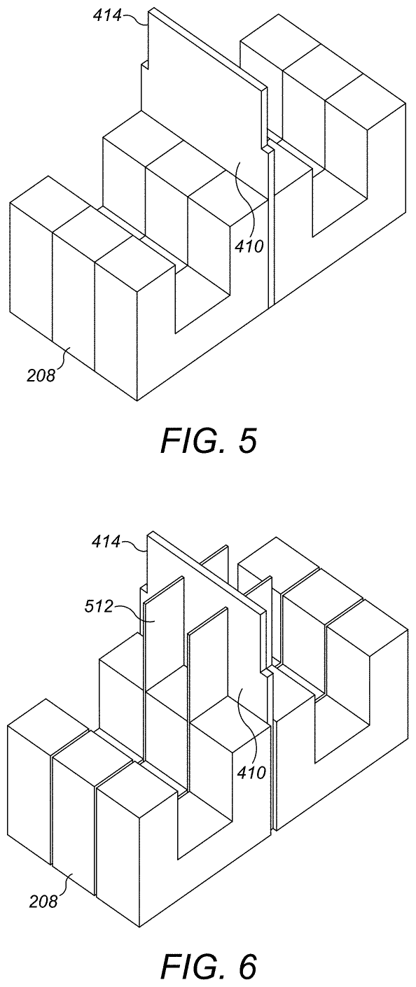

FIG. 4 shows example of a possible housing for a transformer device 100 incorporating the core and winding arrangements of any of the preferred embodiments of FIGS. 1 to 3. FIG. 4 uses the transformer device 100 of FIG. 1 as an example. The transformer device 100 is mounted on the base 106 in combination with a thermally conductive housing 350. The thermally conductive housing 350 includes four corner beams 352 and an outer casing 356. The base 106 may also be considered as portion of the thermally conductive housing 350. A portion of one of the corner beams 352 and the upper face of the outer casing 356 have been omitted in the view of FIG. 4 to allow the interior of the transformer to be seen. The primary thermally conductive plate 110, one or more secondary thermally conductive plates 112, and U-shaped cores 108 are in contact with the base 106 at one end. The corner beams 352 and outer casing 356 are placed on the base 106 so as to surround the core assembly 102 and windings 104. The corner beams 352 may be in thermal contact with the U-shaped cores 108. The outer pair of the secondary thermally conductive plates 112 and corresponding outer surfaces of the U-shaped cores 108 and are in contact with the outer casing 356. The corner beams 352 extend higher above the base 106 than the core assembly 102, so that the thermally conductive plates 110, 112 and U-shaped cores 108 do not contact the upper face of the outer casing 356. This prevents an electrically conducting path being created through the device via the thermally conductive plates 110, 112, which could lead to shorting due to voltages induced by leakage magnetic fields. The individual components may be insulated through various arrangements and structures, for example coating, encasing in cast resin, Kapton® tape, or the like. The heat extracted by the thermally conductive plates 100, 112 can be removed via the base 106 using various different cooling structures.

The utilization of the various thermally conductive plate arrangements used in conjunction with the U-shaped cores provides effective removal of heat from the interior of the transformer device. This allows the correct temperature levels to be maintained inside the transformer device, which prevents damage or failure of the device occurring. Moreover, effective removal of heat from transformers with high loss densities allows operation with a lower temperature rise for a given size transformer. Therefore, use of the thermally conductive plates allows further miniaturization of transformers, such as HPHF transformers, due to reduced temperature related constraints.

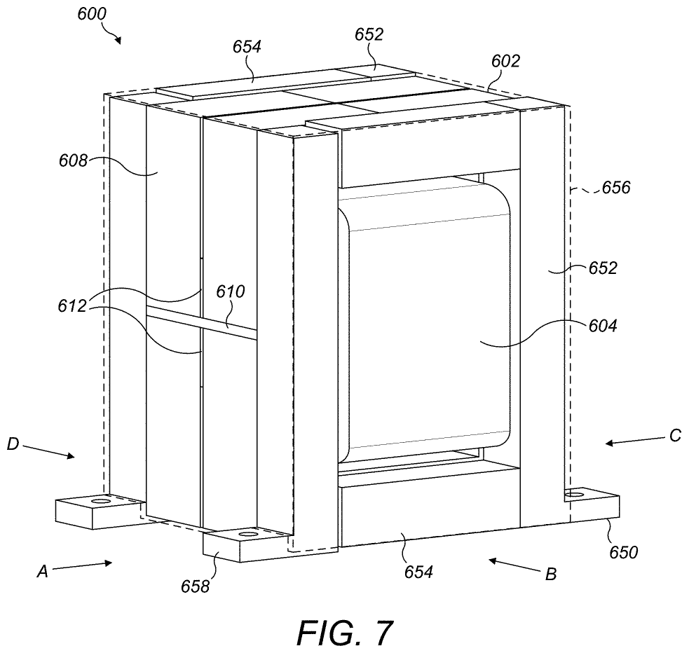

FIGS. 5 and 6 show core assembly and windings arrangements of an alternative preferred embodiment of the present invention, intended for use with a different housing arrangement. FIG. 5 is a cutaway view of a preferred embodiment which includes a primary thermally conductive plate 410, with no secondary conductive plates. The preferred embodiment of FIG. 5 includes twelve U-shaped cores 208, with six shown. The primary thermally conductive plate 410 of this preferred embodiment includes cut-out portions 414. The function of these will be discussed in more detail below with reference to FIGS. 7 to 12.

FIG. 6 is similar to FIG. 5, except for the addition of four secondary thermally conductive plates 512 positioned adjacent to the primary thermally conductive plate 410. Various other combinations of the number of U-shaped cores and number and position of secondary thermally conductive plates could be used, as would be understood by the skilled person.

The core assembly and winding arrangements of FIGS. 5 and 6 may be used with alternative housing arrangements to the thermally conductive housing 350 as described in FIG. 4. A discussion of a preferred embodiment of the present invention including a more sophisticated thermally conductive housing follows, with reference to FIGS. 7 to 13.

FIG. 7 shows a transformer device 600 including a core assembly 602 and windings 604 in conjunction with a thermally conductive housing 650. The transformer windings 604 are the same as those outlined in FIG. 1, and any of the core assembly arrangements discussed in relation to FIGS. 5 and 6, including variants with alternative numbers of core layers and alternative placements of the secondary thermally conductive plates, could be used as the core assembly 602. The particular preferred embodiment shown in FIG. 7 is the eight U-shaped core variant of the preferred embodiment of FIG. 6. In other words, FIG. 7 includes a core assembly arrangement with eight U-shaped cores 608, a primary thermally conductive plate 610 with cut-out portions 614, and a two secondary thermally conductive plates 612 positioned adjacent to the primary thermally conductive plate 610.

The preferred embodiment of FIG. 7 includes a thermally conductive housing 650. The thermally conductive housing 650 includes a frame made up of four corner beams 652 and four edge beams 654. The thermally conductive housing 650 also includes an outer casing 656, has been made transparent in FIG. 7, and is marked by the dashed line. The frame of the thermally conductive housing 650 may be in thermal contact with the U-shaped cores 608. The corner beams 652 extend orthogonally or substantially orthogonally within manufacturing and/or measurement tolerances to the plane of the thermally conductive plate and parallel or substantially parallel within manufacturing and/or measurement tolerances to the core layers. The components of the thermally conductive housing 650 can be made from a material with a high thermal conductivity that will not disrupt the magnetic properties of the transformer, for example a non-magnetic metal could be used, such as aluminum or copper. Each component of the thermally conductive housing 650 may be made out of the same material, or out of various different materials. The material used for the components of the thermally conductive housing 650 may be the same as the material used for the thermally conductive plates 610, 612.

The thermally conductive housing 650 is in thermal contact with the primary thermally conductive plate 610 to allow the thermally conductive housing to transfer the heat removed from the interior of the core by the thermally conductive plates 610, 612. In particular, the thermally conductive plate 610 is in thermal contact with the corner beams 652 towards the end of the thermally conductive plate 610 without cut-out portions. The frame of the thermally conductive housing 650 is in thermal contact with the peripheral core layers to allow further heat extraction from the core assembly 602. The exact placement of the components of the thermally conductive housing 650 and the contact points with the primary thermally conductive plate 610 and core assembly 602 will be discussed further below. The thermally conductive housing 650 can transfer the extracted heat to various cooling structures or arrangements, such as one or more cooling plates to remove heat via conduction and convection, or radiating elements to radiate the heat away. An airflow or flow of coolant over the surface of the thermally conductive housing 650 may be used to remove heat from the device. The corner beams 652 in the preferred embodiment of FIG. 7 include mounting attachments 658 to allow a cooling plate, radiator, or the like to be attached. Various different mounting arrangements can be used. The mounting attachments 658 could be positioned on any of the faces of the transformer device 600.

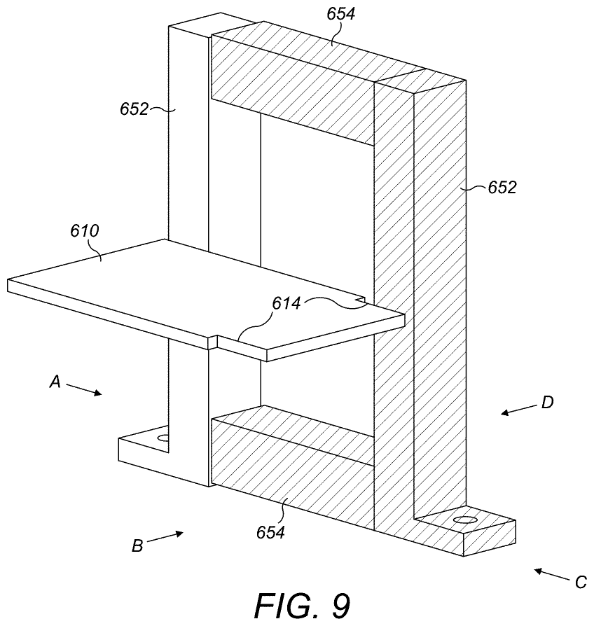

The frame includes gaps which prevent a low resistance electrical path being created through the electromagnetic device via the frame in a direction parallel or substantially parallel within manufacturing and/or measurement tolerances to the axial direction of the windings. In other words, the edge beams 654 of the thermally conductive housing 650 are each connected to only one of the corner beams 652. In the preferred embodiment of FIG. 7, the corner beams 652 on the side labelled C are in contact with the edge beams 654, and the corner beams 652 on the side labelled A are both not in contact with any of the edge beams 654. The edge beams 654 could be connected differently; however, so long as each edge beam 654 only makes contact with one corner beam 652. For example, in another preferred embodiment, the corner beams 652 could be in contact with the edge beams 654 at side A and not at side C. Alternatively, each of the edge beams 654 could be connected to a different corner beam 652. Ensuring each edge beam 654 only contacts one corner beam 652 means that there are no low resistance electrical conduction paths through the device via the frame, which could cause an electrical short due to induced voltages coming from any leakage magnetic field. This will be discussed in greater depth in FIG. 9.

The core assembly 602, windings 604, and thermally conductive housing 650 may be attached together by various structures or arrangements. Typically, the core assembly 602 is held together through adhesive, a thermally conductive cement, through use of insulation tape, or the like. The core assembly 602 and windings 604 are then secured inside thermally conductive housing 650, which provides additional support. Additional adhesive, resin, insulating tape, or the like can be used throughout the structure to provide additional insulation between the components.

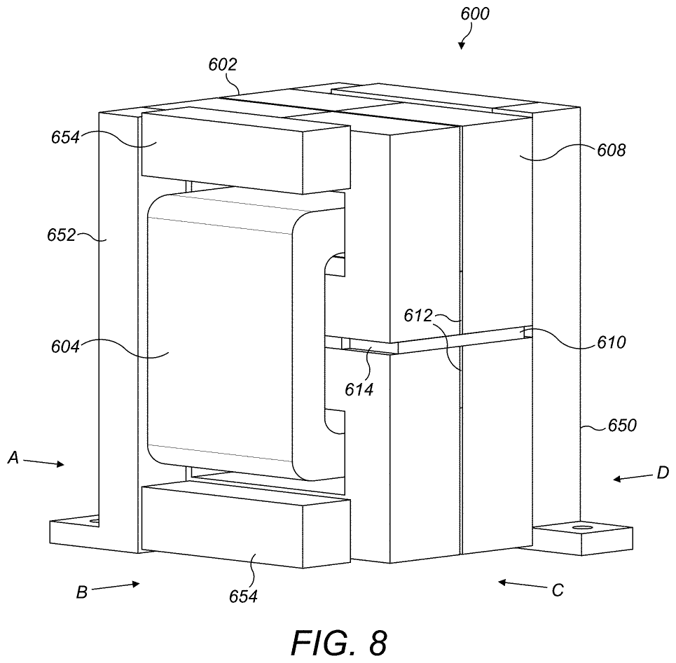

FIG. 8 gives a rear perspective view of the transformer device 600 of FIG. 7, showings sides B and C of FIG. 7. One of the corner beams 652 has not been included in the frame FIG. 8 to allow the interior structure of the transformer device 600 to be viewed. The outer casing 656 has also been omitted from FIG. 8. The cut-out portions 614 in the primary thermally conductive plate 610 can be seen in FIG. 8. The cut-out portions 614 prevent contact between the primary thermally conductive plate 610 and the corner beams 652 on the cut-out portions side of the transformer device 600. Similar to the gaps between the corner beams 652 and the edge beams 654 discussed in FIG. 7, the gaps created by the cut-out portions 614 prevent an electrical path being created parallel or substantially parallel within manufacturing and/or measurement tolerances to the axial direction of the windings between the two sides of the device 600 via the primary thermally conductive plate 610, thus preventing an electrical short. This is also discussed in more detail in FIG. 9.

FIG. 9 provides the same view as FIG. 8, but with all components omitted except for the primary thermally conductive plate 610, and the corner beams 652 and edge beams 654 on the side of the transformer device labelled D. As can be seen in FIG. 9, due to the cut-out portions 614 the two corner beams 652 on opposite sides of the transformer device (side A and side C) are not in electrical contact with each other via the primary thermally conductive plate 610. The edge beams 654 each then only contact one of the corner beams 652, with a gap left between the edge beam 654 and the other corner beam 652. This means that an electrically conducting path is not created through the device (between sides A and C) due to the primary thermally conductive plate 610 or the edge beams 654. The shading in FIG. 9 shows that a first of the corner beams 652 is in electrical contact with the primary thermally conductive plate 610, and the second corner beam 652 is in electrical contact with the two edge beams 654, and those two groups of components are not in electrical contact with each other. One or both of the edge beams 654 could be connected to the same corner beam 652 as the primary thermally conductive plate 610, provided that edge beam 654 then did not connect to the other corner beam 652.

In one preferred embodiment, the dimensions of the primary thermally conductive plate 610 are approximately 150 mm by approximately 90 mm within manufacturing and/or measurement tolerances, the cut-out portions are approximately 30 mm by approximately 5 mm within manufacturing and/or measurement tolerances, and the plate is approximately 5 mm to approximately 10 mm thick within manufacturing and/or measurement tolerances. The cut-out portions therefore provide an approximately 5 mm spacing within manufacturing and/or measurement tolerances between the primary thermally conductive plate 610 and the corner beams 652. The dimensions of the primary thermally conductive plate 610 are carefully selected to maximize the contact area with the U-shaped cores 608, to maximize heat removal, while avoiding the possibility of shorting. The gaps between the corner beams 652 and edge beams 654 may also be approximately 5 mm to approximately 10 mm within manufacturing and/or measurement tolerances in some preferred embodiments.

Ensuring that no low resistance electrically conducting path is created through the primary thermally conductive plate 610 or edge beams 654 prevents any electrical shorts from occurring. However, the thermal contact between the primary thermally conductive plate 610 and corner beams 652 at the end of the primary thermally conductive plate 610 without cut-out potions allows heat to be removed from the interior of the core assembly via the primary thermally conductive plate. Moreover, the corner beams 652 and edge beams 654 are in thermal contact with the U-shaped cores 608 in the peripheral core layers to allow further heat to be removed from the core assembly. The thermally conductive plates 610, 612 and corner and edge beams 652, 654 are therefore able to transfer heat away from the core assembly 602, without creating an electrical conduction path through the transformer device 600. If an electrical conduction path was created, induced voltages due to any leakage magnetic fields from the core could cause circulating currents to flow through the device, which would reduce efficiency and generate additional losses.

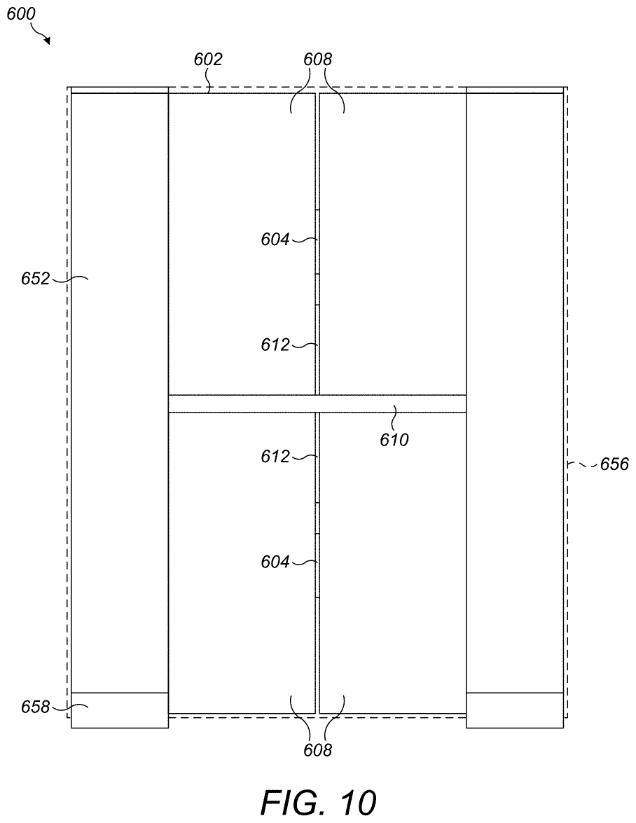

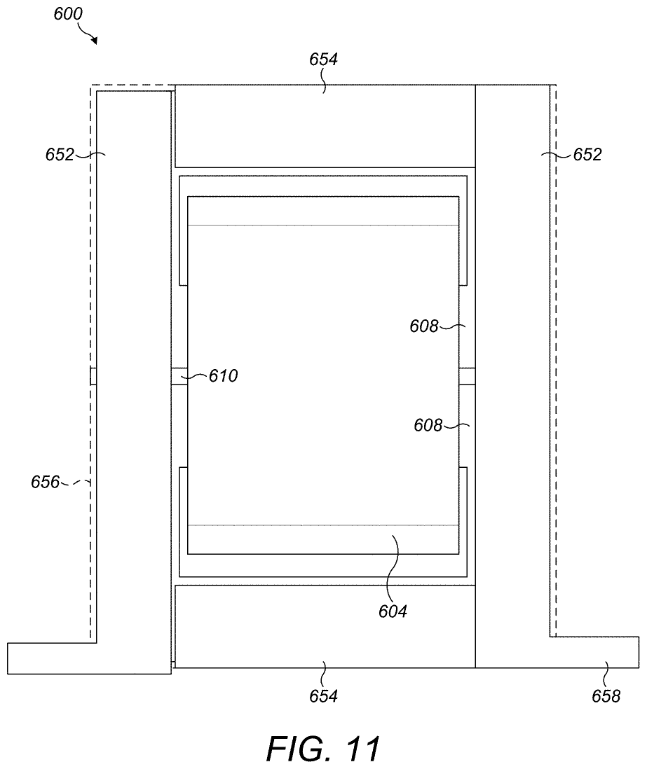

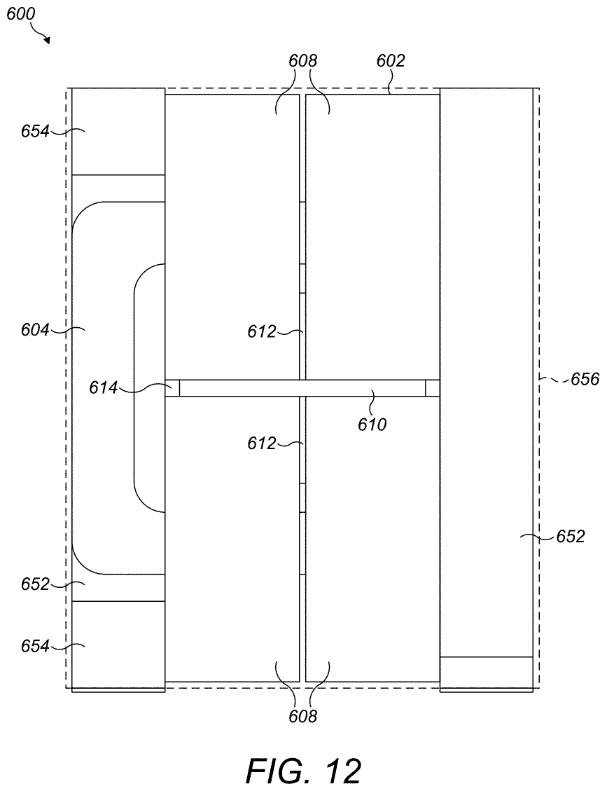

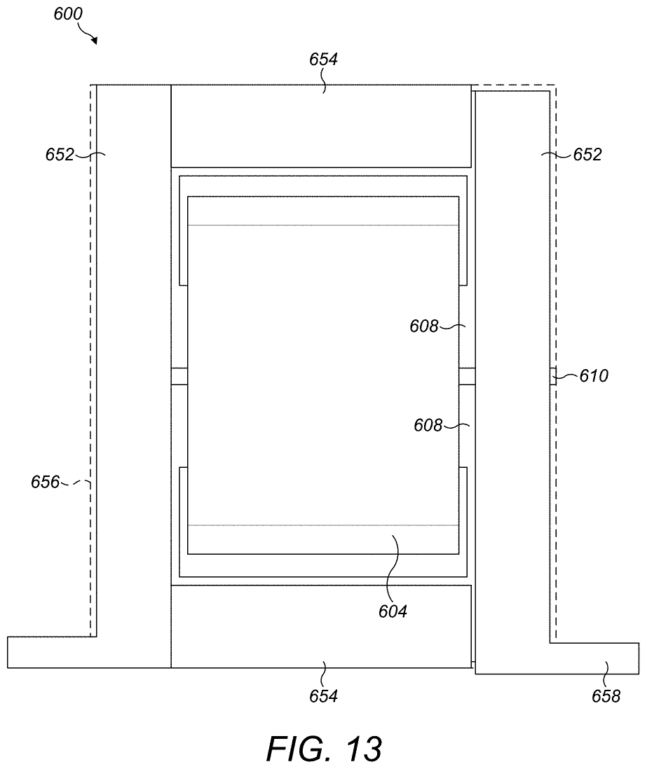

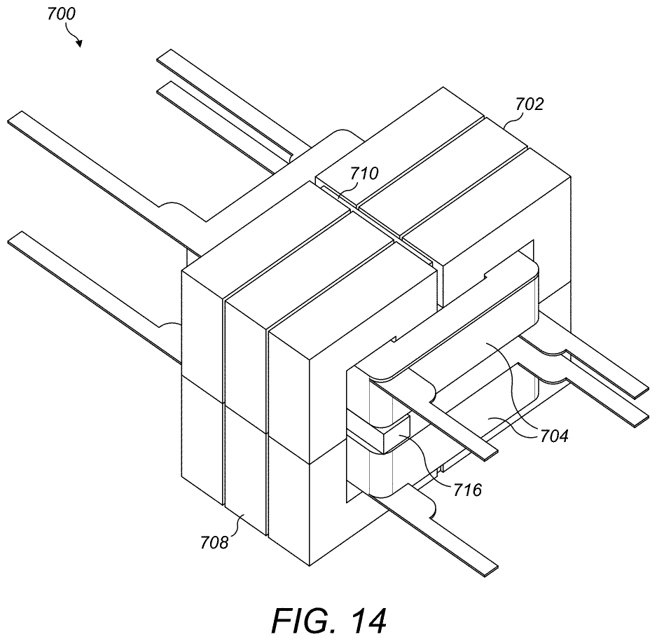

The outer casing 656 is also connected so as to prevent any electrical shorts occurring through the center of the device, as can be seen from FIGS. 10 to 13. FIG. 10 gives a front view of the preferred embodiment of FIG. 7, marked by direction A in FIG. 7. FIG. 11 gives a side view of the preferred embodiment of FIG. 7, marked by direction B in FIG. 7. FIG. 12 gives a rear view of the preferred embodiment of FIG. 7, marked by direction C in FIG. 7. In FIG. 12 the same corner beam 652 as in FIG. 7 has been omitted, to allow the internal structure to be viewed. FIG. 13 gives a side view of the preferred embodiment of FIG. 7, marked by direction D in FIG. 7.

As shown in FIGS. 10 to 13, particularly the side views of FIGS. 11 and 13, the primary thermally conductive plate 610 only contacts the outer casing 656 at the end of the primary thermally conductive plate 610 without the cut-out portions 614. A gap is formed between the end of the primary thermally conductive plate 610 with cut-out portions 614 and the outer casing 656. Therefore, when transformer device is fully constructed, there is no low resistance electrical path created in the axial direction of the windings, between the two opposite faces of the outer casing 656, side A and side C, through the primary thermally conductive plate 610. This again prevents an electrical short occurring through the device. However, as the end of the primary thermally conductive plate 610 without cut out portions is in thermal contact with the outer casing, heat can be removed from the primary thermally conductive plate via the outer casing 656.

Each of the secondary thermally conductive plates 612 may also contact the outer casing 656 at one end of each of the secondary thermally conductive plates (not shown), to allow heat to be transferred from the secondary thermally conductive plates directly to the outer casing 656. In this case, a gap is formed between the outer casing 656 and the other end of each of the secondary thermally conductive plates 612, so as to prevent a low resistance electrical path being created via the one or more secondary thermally conductive plates through the device parallel or substantially parallel within manufacturing and/or measurement tolerances to the axial direction of the one or more sets of windings. In the case where the secondary thermally conductive plates 612 are adjacent to and in contact with the primary thermally conductive plate 610, the secondary thermally conductive plates 612 can contact the outer casing 656 on the same side as the primary thermally conductive plate 610 in order to avoid a low resistance electrical path through the device. When the secondary thermally conductive plates 612 are not in contact with the primary thermally conductive plate 610, for example, when the secondary thermally conductive plates 612 are positioned towards the outer edge of the core assembly 602, the secondary thermally conductive plates 612 may contact the outer casing 656 on the opposite side of the device to the primary thermally conductive plate 610, provided only one end of each of the secondary thermally conductive plates 612 is in contact with the outer casing 656.

It can be further seen from FIGS. 10 to 13 that no low resistance electrical path is created through the primary thermally conductive plate 610 between one side (side A) of the outer casing 656 and the corner beams 652 on the opposite side (side C) of the device, due to the cut out portions and the gap between the outer casing at the end of the primary thermally conductive plate with cut-out portions. Moreover, as outlined above in relation to FIG. 9, the cut-out portions 614 mean that no low resistance electrical path is created through the primary thermally conductive plate 610 between the corner beams 652 at opposite ends of the primary thermally conductive plate 610. The configuration of the thermally conductive housing 650 and thermally conductive plates 610, 612 therefore prevent any unwanted conduction paths being created through the center of the device along the axial direction of the windings 604. This prevents any circulating currents from being produced.

In the preferred embodiment shown in FIGS. 10 to 13, the outer casing 656 is in electrical contact with the end of the primary thermally conductive plate 610 without cut-out portions, and is in electrical contact with the portion of the frame that is not in electrical contact with the thermally conductive plate 610 due to the cut-out portions and the gaps in the frame. In other words, the outer casing 656 is in contact with the edge beams 654, the corner beams 652 connected to the edge beams, and the end of the primary thermally conductive plate 610 without cut-out portions 614. The outer casing 656 is not in direct contact with the U-shaped cores 608. Connecting the outer casing 656 in this way provides strong thermal conductive properties to remove heat extracted by the thermally conductive plates 610, 612.

However, referring back to FIG. 9, the two differently shaded halves of FIG. 9, which are shown as not in electrical contact with each other via to the primary thermally conductive plate 610 or edge beams 654, are connected via the outer casing 656. This is acceptable as any electrical currents that are induced in the thermally conductive housing 650 are due to leakage fields, which drop significantly as the distance from the transformer core increases. Therefore, at the distance of the outer casing 656 any induced potential in the outer casing 656 by the leakage fields is almost negligible. This means that any potential paths through the outer casing 656 are not significant, and such paths are commonly found in devices with metal casings.

In preferred embodiments of the present invention, the thermally conductive plates 610, 612 and the frame of the thermally conductive housing 652, 654 mean that conductive portions are brought closer to the core than typical in transformers. The configuration described above therefore seeks to prevent any low resistance paths being formed in these portions, where the leakage voltages are large enough to cause significant circulating currents. The only low resistance paths that remain through the thermally conductive housing 650 are via the outer casing 656, which are not significant compared to potential paths through the center of the device.

The transformer device 600 of the present preferred embodiment allows excellent management of generated heat. Heat generated can be extracted and removed via the thermally conductive plates 610, 612 and the thermally conductive housing 650, preventing overheating of the device and allowing miniaturization. Moreover, the configuration of the cut-out portions 614 and thermally conductive housing 650 prevents any low resistance electrical paths being formed through the center of the device, thus preventing any short circuits from being formed, leading to circulating currents and additional losses.

FIG. 14 shows a core assembly 702 and windings 704 of a transformer device 700 of another preferred embodiment of the present invention, which includes additional thermally conductive blocks. Any of the previous core assembly and winding arrangements could be used in the preferred embodiment of FIG. 14. The core assembly arrangement of FIG. 5 has been used as an example core assembly 702 including twelve U-shaped cores 708 and a primary thermally conductive plate 710 with cut-out portions. In the preferred embodiment of FIG. 14 two sets of Murata's pdqb type windings have been used as the windings 704. Each set of windings may include a primary and secondary coil, for example, or may instead contain a single coil. The windings use flat wires and are formed from square turns or substantially square turns within manufacturing and/or measurement tolerances. The windings 704 include input and output terminals that extend orthogonally or substantially orthogonally within manufacturing and/or measurement tolerances to the one or more core layers. However, in another preferred embodiment, these terminals may extend in a direction parallel or substantially parallel within manufacturing and/or measurement tolerances to the core layers and orthogonal or substantially orthogonal within manufacturing and/or measurement tolerances to the plane of the primary thermally conductive plate.

A pair of thermally conductive blocks 716 are disposed between the two sets of windings 704, adjacent to and in thermal contact with the windings 704. Alternatively, only one set of windings may be used, with the thermally conductive blocks 716 positioned adjacent to one side of the windings, or placed within the windings between two turns. The thermally conductive blocks 716 extend orthogonally or substantially orthogonally within manufacturing and/or measurement tolerances to the axial direction of the windings. The thermally conductive blocks 716 are in thermal contact with the windings 704 to transfer heat away from the windings.

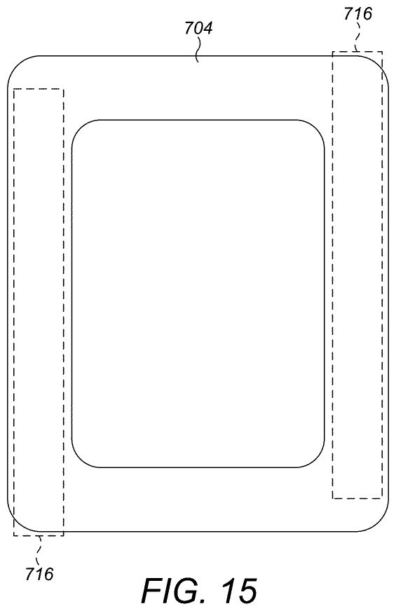

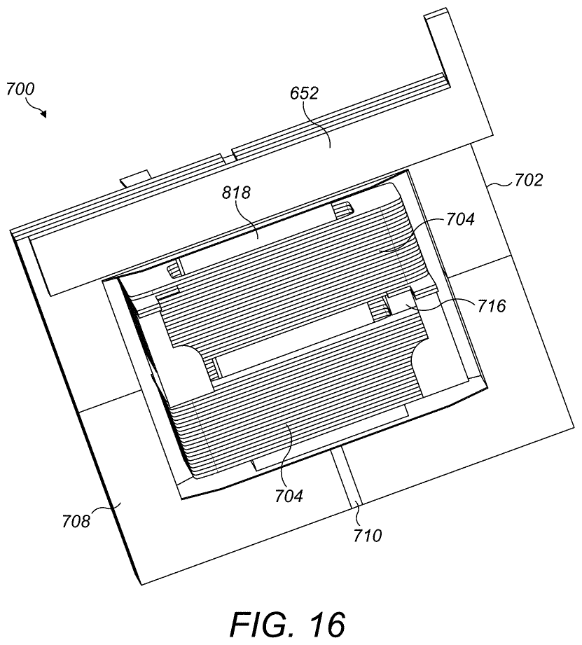

The preferred embodiment of FIG. 14 includes two thermally conductive blocks 716, only one of which can be seen in the view shown in FIG. 14. A single thermally conductive block 716 may be used instead however, or a plurality of thermally conductive blocks may be used. In the preferred embodiment of FIG. 14, the second thermally conductive block 716 is positioned on the rear side of the device. FIG. 15 shows the arrangement of the thermally conductive blocks 716 of this preferred embodiment in more detail.

FIG. 15 is a plan view of the windings 704 and thermally conductive blocks 716 of FIG. 14 in isolation. In the present preferred embodiment, the thermally conductive blocks 716 are positioned on opposite sides of the device in a rotationally symmetric fashion about the winding axis of the one or more sets of windings. The thermally conductive blocks 716 remove heat from the windings in a similar fashion to the thermally conductive plates for the core assembly. These thermally conductive blocks 716 provide low thermal resistance paths for the heat generated in the windings to flow to the radiation surfaces. The thermally conductive blocks may be thermally connected to a cooling structure such as a cooling plate or radiation element. The thermally conductive blocks 716 may be made of a similar thermally conductive non-magnetic material as used for the thermally conductive plates of the previous preferred embodiments.

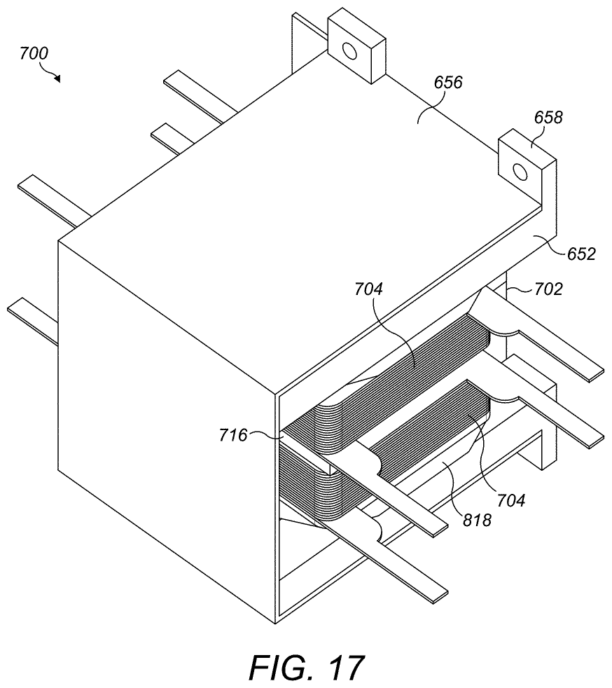

The preferred embodiment of FIG. 14 may be used in combination with the thermally conductive housing 650 of FIG. 7. The thermally conductive blocks 716 may be in thermal contact with either the edge beams 654 when the thermally conductive blocks 716 are positioned parallel or substantially parallel within manufacturing and/or measurement tolerances to the corner beams 652, or with the outer casing 656 when the thermally conductive blocks 716 are positioned orthogonal or substantially orthogonal within manufacturing and/or measurement tolerances to both the corner and edge beams 652, 654. FIGS. 16 and 17 show the later of these two possibilities. When used in combination with the thermally conductive housing 650, the heat removed by the thermally conductive blocks can be removed via the thermally conductive housing 650.

The thermally conductive blocks 716 may thermally contact the thermally conductive housing 650 at one end of each of the thermally conductive blocks only, to prevent an electrical path being created through the thermally conductive blocks 716. This prevents any circulating currents being formed through the thermally conductive blocks due to induced voltages from the main magnetic field. The dimensions of the thermally conductive blocks 716 are carefully selected to maximize the contact area with the windings 704 in order to maximize heat removal, while avoiding the possibility of shorting. In one preferred embodiment, the gap between the thermally conductive blocks 716 and the thermally conductive housing 650 is approximately 10 mm within manufacturing and/or measurement tolerances. When this gap is larger, less heat is extracted, but the gap should be large enough to prevent any shorting.

As seen in FIG. 15, in this preferred embodiment the thermally conductive blocks 716 are positioned in a rotationally symmetric fashion about the winding axis of the one or more sets of windings, so as to thermally contact the thermally conductive housing 650 on opposite sides of the device to each other. However, in another preferred embodiment, both thermally conductive blocks 716 could thermally contact the thermally conductive housing 650 on the same side of the device. The preferred embodiment shown in FIG. 15 allows heat to be extracted more evenly from both sides of the device.

Other arrangements could be used, as would be understood by the skilled person. For example, four thermally conductive blocks 716 all extending perpendicular or substantially perpendicular within manufacturing and/or measurement tolerances to each other could be used. In other words, an additional two thermally conductive blocks could be included in the preferred embodiment of FIG. 15, with the additional thermally conductive blocks entering the windings in the top left corner and the bottom right corner of FIG. 15, and extending perpendicular or substantially perpendicular within manufacturing and/or measurement tolerances to the existing thermally conductive blocks. All of the thermally conductive blocks in such a preferred embodiment would have to extend over a shorter distance, so as to maintain a gap between each of the thermally conductive blocks. Two of these thermally conductive blocks 716 would be in thermal contact with the edge beams 654, and the other two would be in thermal contact with the outer casing 656.

The wires in the windings 704 are insulated from the thermally conductive blocks 716. Various insulation structures or arrangements can be used, such as coating the windings or thermally conductive blocks in an insulator, or encasing the windings and thermally conductive blocks in a cast resin or the like. The windings could also be insulated through the use of Kapton® tape or the like. The thermally conductive blocks can be used in combination with Murata's pdqb type windings, to further utilize the advantages of pdqb windings.

As well as the heat removed from the core assembly 702 due to the primary thermally conductive plate 710, and secondary thermally conductive plates if these are present, the thermally conductive blocks 716 remove additional heat from the windings. This can further assist with temperature control of the transformer device, preventing overheating and allowing miniaturization.

FIGS. 16 and 17 show partially constructed views of the transformer device 700 of FIG. 14 with the thermally conductive housing 650. In the preferred embodiments of FIGS. 16 and 17, an additional electrical insulation sheet 818 is included between the windings and the core assembly 702. The electrical insulation sheet 818 covers the surface of the central portion of the core assembly 702 that includes the primary thermally conductive plate 710. In other words, the insulation sheet 818 is a square cross sectioned tube that is disposed on the surface of the central pillar of the transformer core to prevent any electrical contact between the windings 704 and the core assembly 702. The insulating sheet 818 also includes flange portions at either end, which can be seen best in the view of FIG. 17. These flange portions are disposed between the core assembly 702 and the outer face of the windings 704, again to prevent electrical contact between the windings 704 and the U-shaped cores 708 of the core assembly 702. In other preferred embodiments, the entire inner surface of the core assembly 702 (the surfaces in proximity to the windings 704) may be covered in an electrically insulating sheet.

In the preferred embodiments of FIGS. 16 and 17, the heat extracted by both the thermally conductive plates and the thermally conductive blocks 716 is transferred to the thermally conductive housing 650. Although the thermally conductive blocks 716 are in thermal contact with the thermally conductive housing 650, the thermally conductive blocks may be electrically insulated so as not to be in electrical contact with the thermally conductive housing. Moreover, in the preferred embodiment of FIG. 16 the input and output terminals of the windings are folded over the ends of the thermally conductive blocks 716. Although this prevents physical contact between the thermally conductive blocks 716 and the thermally conductive housing 650, the input and output terminals do not prevent thermal contact between these components, such that the thermally conductive blocks 716 still facilitate heat removal from the windings and transfer heat to the thermally conductive casing 650. The thermally conductive blocks 716 therefore transfer heat away from the interior of the device and dramatically reduce the hot spot temperature of the device.

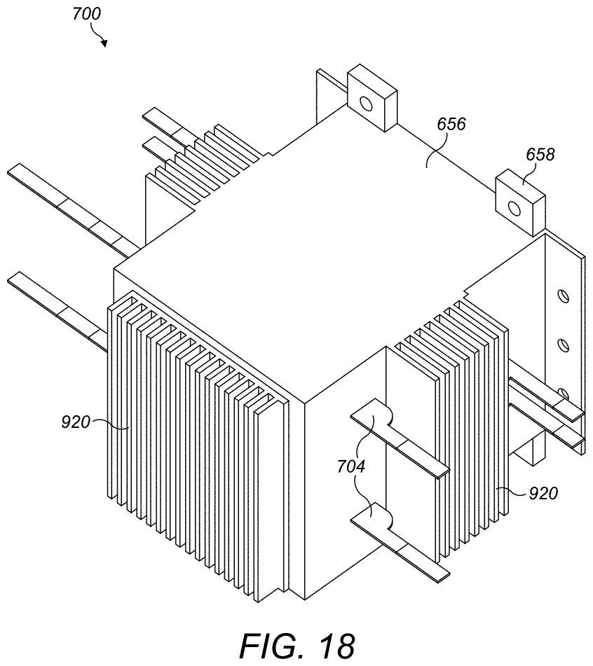

The heat extracted by the thermally conductive blocks 716 and transferred to the thermally conductive housing 650 can be removed by various cooling structures, such as mounting on a cooling plate, use of an airflow or flow of coolant over the surface of the thermally conductive housing 650, radiating elements, or the like. For example, FIG. 18 shows a complete construction of a preferred embodiment of the transformer device 700 of FIG. 14, which optionally includes radiating elements 920 mounted on and thermally connected to the outer casing of the thermally conductive housing 650. The radiating elements 920 increase the surface area of the device, to increase the heat loss via radiation and convection. The radiating elements 920 may be cooled using an airflow, for example. The core assembly and winding arrangements of any of the previous preferred embodiments could be used in combination with the thermally conductive housing 650 and radiating elements 920 of FIG. 18.

The various concepts and structures described in the preferred embodiments contribute to the optimization of the thermal performance of the transformer device. Improved thermal management can extend the lifetime of the device, as well as allowing miniaturization of the device. This concept can be used in any electromagnetic device that is constructed with a UU type or UI core assembly that provides a middle separation in the magnetic path parallel or substantially parallel within manufacturing and/or measurement tolerances to the direction of the flow of the magnetic flux. The principle can be used in any transformer, such as a HPHF transformer, or any high power inductor application where the magnetic core is constructed with an assembly of UU cores or UI cores.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electromagnetic device comprising:
one or more sets of windings; and
a core assembly including:
one or more core layers, wherein each core layer of the one or more core layers includes two closed cores, and each of the two closed cores is constructed either from two U-shaped cores or from a U-shaped core and an I-shaped core; and
a thermally conductive plate that is disposed between the two closed cores along an axial direction of the one or more sets of windings to bisect the one or more core layers; wherein:
each of the one or more sets of windings passes through each of the closed cores.

2. The electromagnetic device of claim 1, wherein the thermally conductive plate is in thermal contact with the closed cores to transfer heat away from the interior of the core assembly.

3. The electromagnetic device of claim 1, wherein
the one or more core layers includes a plurality of core layers; and
the core assembly further includes one or more secondary thermally conductive plates disposed between the plurality of core layers.

4. The electromagnetic device of claim 3, wherein the one or more secondary thermally conductive plates are disposed in a plane parallel or substantially parallel to the axial direction of the one or more sets of windings and orthogonal or substantially orthogonal to a plane of the thermally conductive plate.

5. The electromagnetic device of claim 3, wherein the one or more secondary thermally conductive plates are adjacent to and in thermal contact with the thermally conductive plate.

6. The electromagnetic device of claim 1, further comprising a thermally conductive housing including a frame and an outer casing; wherein
the thermally conductive housing is in thermal contact with at least the thermally conductive plate of the core assembly.

7. The electromagnetic device of claim 6, wherein the frame includes gaps which prevent a low resistance electrical path being created via the frame through the electromagnetic device parallel or substantially parallel to the axial direction of the one or more sets of windings.

8. The electromagnetic device of claim 6, wherein:
the frame of the thermally conductive housing includes corner portions which extend orthogonally or substantially orthogonally to a plane of the thermally conductive plate and parallel or substantially parallel to the one or more core layers;
the thermally conductive plate includes a first end and a second end; and
the thermally conductive plate includes cut-out portions at the first end, which prevent electrical contact with the corner portions at the first end of the thermally conductive plate to prevent a low resistance electrical path being created via the thermally conductive plate through the electromagnetic device parallel or substantially parallel to the axial direction of the one or more sets of windings.

9. The electromagnetic device of claim 8, wherein the thermally conductive plate is in thermal contact with the corner portions towards the second end of the thermally conductive plate.

10. The electromagnetic device of claim 8 wherein:
the thermally conductive plate is in thermal contact with the outer casing of the thermally conductive housing at the second end of the thermally conductive plate; and
a gap is formed between the outer casing and the first end of the thermally conductive plate prevent a low resistance electrical path being created via the thermally conductive plate through the electromagnetic device parallel or substantially parallel to the axial direction of the one or more sets of windings.

11. The electromagnetic device of claim 6, wherein
the one or more core layers includes a plurality of core layers;
the core assembly further includes one or more secondary thermally conductive plates disposed between the plurality of core layers;
the one or more secondary thermally conductive plates are in contact with the outer casing at one end of each of the one or more secondary thermally conductive plates; and
a gap is formed between the outer casing and another end of each of the one or more secondary thermally conductive plates to prevent a low resistance electrical path being created via the one or more secondary thermally conductive plates through the electromagnetic device parallel or substantially parallel to the axial direction of the one or more sets of windings.

12. The electromagnetic device of claim 6, wherein the frame of the thermally conductive housing is in thermal contact with peripheral core layers of the one or more core layers.

13. The electromagnetic device of claim 1, further comprising one or more thermally conductive blocks disposed adjacent to the one or more sets of windings and extending orthogonally or substantially orthogonally to the axial direction of the one or more sets of windings; wherein
the thermally conductive blocks are in thermal contact with the one or more sets of windings to transfer heat away from the one or more sets of windings.

14. The electromagnetic device of claim 13, further comprising a thermally conductive housing; wherein
the one or more thermally conductive blocks are in thermal contact with the thermally conductive housing.

15. The electromagnetic device of claim 14, wherein a gap is formed between one end of each of the one or more thermally conductive blocks and the thermally conductive housing to prevent a low resistance electrical path being created through the electromagnetic device via the one or more thermally conductive blocks.

16. The electromagnetic device of claim 13, wherein
the one or more thermally conductive blocks includes two thermally conductive blocks; and
the two thermally conductive blocks are positioned on opposite sides of the one or more sets of windings and are rotationally symmetric about the winding axis of the one or more sets of windings.

17. The electromagnetic device of claim 1, further comprising a thermally conductive housing; wherein
the thermally conductive plate is in thermal contact with a cooling structure either directly or indirectly via the thermally conductive housing.

18. The electromagnetic device of claim 13, further comprising a thermally conductive housing; wherein
the one or more thermally conductive blocks are in thermal contact with a cooling structure either directly or indirectly via the thermally conductive housing.

19. The electromagnetic device of claim 17, wherein the cooling structure includes one or more cooling plates and/or one or more radiating elements.

20. A core assembly for an electromagnetic device comprising:
one or more core layers, wherein each of the one or more core layers includes two closed cores, and each of the two closed cores is constructed either from two U-shaped cores or from a U-shaped core and an I-shaped core; and
a thermally conductive plate that is disposed between the two closed cores to bisect the one or more core layers.
